(19) United States
(12) Patent Application Publication
(10) Pub. No.: US 2023/0400415 A1
(43) Pub. Date: Dec. 14, 2023

(54) SELF-HEALABLE CHEMICAL DETECTING SENSOR EMBEDDING TRANSITION METAL-ADSORBED PAA-PVA-BORAX FIBER-GEL

(71) Applicant: UIF (University Industry Foundation), Yonsei University, Seoul (KR)

(72) Inventors: Won Gun KOH, Seoul (KR); Jeong Woo HAM, Seoul (KR); Jin Woo OH, Busan (KR); Kyoung A. LIM, Busan (KR)

(21) Appl. No.: 18/130,874

(22) Filed: Apr. 4, 2023

(30) Foreign Application Priority Data
Apr. 5, 2022 (KR) 10-2022-0042334

(51) Int. Cl. G01N 21/78; C08L 33/02; C08L 29/04; C08K 3/38; D01D 5/00; D02J 13/00

(52) U.S. Cl. CPC G01N 21/78; C08L 33/02; C08L 29/04; C08K 3/38; D01D 5/0038; D02J 13/00; C08L 2312/00; C08K 2003/387; C08L 2203/12; D10B 2321/06; D10B 2321/08; D10B 2505/00

(57) ABSTRACT

Provided is a self-healable hydrogel composite including a polyacrylic acid-polyvinyl alcohol-borax (PAA-PVA-borax) fiber gel onto which transition metal ions are adsorbed. The present invention can effectively seal spaces where there is a risk of chemical leakage and visually detect the presence or absence of leakage utilizing the elongation and self-healing properties of polyvinyl alcohol and borax hydrogels.

### CROSS-REFERENCE TO RELATED APPLICATION

This application claims priority under 35 U.S.C. § 119(b) to Korean Application No. 10-2022-0042334, filed Apr. 5, 2022, the disclosure of which is incorporated herein by reference in its entirety.

### BACKGROUND

### 1. Field of the Invention

The present invention relates to a self-healable chemical detection sensor in which nanofibers based on polyacrylic acid and polyvinyl alcohol are manufactured to adsorb transition metals, and then subjected to hydrogelation, and the sensor is based on the principle that a color changes when a transition metal ion binds to a ligand.

### 2. Discussion of Related Art

From heavy metals in industrial wastewater to toxic gases in the atmosphere, chemical detection technology is essential for people's safety. Widespread chemical detection technology has its roots in gas sensors using heated platinum wires that were commercialized in 1923. Thereafter, a semiconductor-type sensor using a thin tin oxide film was developed and widely used, and currently, a detection sensor manufactured using various metal oxides such as iron oxide has been developed and commercialized.

Recently, chemical material detection sensors in use at industrial sites are roughly classified into two types. The first is a portable detector equipped with a semiconductor or electrochemical system, and the second is a mountable sensor that detects chemicals at a fixed location. The above sensors generally have a disadvantage in that they are not efficient in locating a leakage location and a leakage material in detail due to detecting only chemicals in a local area. Further, since the manufacturing cost of a sensor and the sales price including the same are high, there is also a problem in that it is difficult to systematically monitor whether or not a leakage occurs by installing sensors at all leakage risk points.

In the present invention, unlike sensors in the related art, an attempt has been made to develop a fiber gel sensor capable of detecting the type and concentration of a chemical only by the change in color caused by the binding between a transition metal ion and a ligand. In addition, a self-healable hydrogel was used to adhere to the joints and cracks of containers or pipes where there is a risk of leakage of chemicals, thereby enabling systematic leakage management.

### SUMMARY OF THE INVENTION

An object of the present invention is to manufacture a fiber gel sensor onto which a transition metal is adsorbed, which can be manufactured in large quantities at low cost by a simple method, and to detect a chemical after the fiber gel sensor is included in a self-healable hydrogel to adhere the self-healable hydrogel to a point where a leakage is likely occur.

To achieve the object of the present invention as described above, provided is a self-healable hydrogel including:
a polyacrylic acid-polyvinyl alcohol-borax (PAA-PVA-Borax) fiber gel with dispersed transition metal ions,
in which the PAA and PVA are thermally cross-linked, and
the PVA and Borax are covalently bonded.

Furthermore, the present invention provides a chemical detection sensor including the fiber gel and the self-healable hydrogel.

Further, the present invention provides a method for producing a self-healable hydrogel composite, the method including: a first step of preparing a polyacrylic acid-polyvinyl alcohol (PAA-PVA) nanofiber precursor solution;
a second step of producing polyacrylic acid-polyvinyl alcohol (PAA-PVA) nanofibers by electrospinning the nanofiber precursor solution of the first step, and then thermally cross-linking the electrospun nanofiber precursor solution;
a third step of adsorbing transition metal ions by mixing the polyacrylic acid-polyvinyl alcohol (PAA-PVA) nanofibers of the second step with a transition metal ion solution; and
a fourth step of manufacturing a polyacrylic acid-polyvinyl alcohol-borax (PAA-PVA-Borax) fiber gel by mixing the polyacrylic acid-polyvinyl alcohol (PAA-PVA) nanofibers onto which the transition metal ions are adsorbed of the third step with a borax solution; and
a fifth step of forming a polyvinyl alcohol-borax (PVA-Borax) hydrogel matrix by allowing the polyacrylic acid-polyvinyl alcohol-borax (PAA-PVA-Borax) fiber gel onto which the transition metal ions are adsorbed of the fourth step to react with a polyvinyl alcohol (PVA) solution.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a schematic view of the process of manufacturing a self-healable hydrogel composite;

FIG. 2A shows the results of a tensile test of the self-healable hydrogel;

FIG. 2B shows a self-healing power test of the self-healable hydrogel;

FIG. 3 is a set of FT-IR graphs of the fiber gel according to the degree of thermal cross-linking;

FIG. 4A is a set of comparison photographs of dried fiber gels according to the degree of thermal cross-linking;

FIG. 4B is a set of comparison photographs of SEM images of dried fiber gels according to the degree of thermal cross-linking;

FIG. 5 is a set of FT-IR comparison graphs of PAA-PVA nanofibers and PAA-PVA-Borax fiber gels;

FIG. 6 is a set of comparison photographs of the adhesiveness of the self-healable hydrogel composite according to various materials;

FIG. 7 is a set of color change photographs of the fiber gel sensor according to the leakage of liquid chemicals;

FIG. 8 is a set of color change photographs of the fiber gel sensor according to the concentration of the gas phase ammonia;

FIG. 9A is a fiber gel RGB value change graphs according to the concentration of gas phase NH₄OH;

FIG. 9B is a fiber gel Blue value change graph according to the concentration of gas phase NH₄OH;

FIG. 9C is a fiber gel Blue/Red conversion value change graph according to the concentration of gas phase NH₄OH;

FIG. 10A is a modeling photo of detecting ammonia leakage after sealing a damaged rubber hose with a self-healable hydrogel composite;

FIG. 10B is a set of photos of detecting ammonia leakage after sealing a damaged rubber hose with a self-healable hydrogel composite;

FIG. 11 is a set of photographs of an increase in the pH of distilled water in which the end of the rubber hose is immersed due to leaked ammonia gas after sealing the damaged rubber hose with the self-healable hydrogel composite; and

FIG. 12 is an image of the results of detecting various liquid chemicals using fiber gels onto which different transition metal ions are adsorbed.

### DETAILED DESCRIPTION OF EXEMPLARY EMBODIMENTS

Hereinafter, the configuration of the present invention will be described in detail.

The present invention provides a fiber gel and self-healable hydrogel composite and a method for producing the same.

It is possible to include a self-healable hydrogel including a polyacrylic acid-polyvinyl alcohol-borax (PAA-PVA-Borax) fiber gel with dispersed transition metal ions,
in which the PAA and PVA are thermally cross-linked, and
the PVA and Borax are covalently bonded.

As used herein, the term “self-healable” refers to the property capable of recovering original physical properties and characteristics by self-healing physical damage occurring in the material during use.

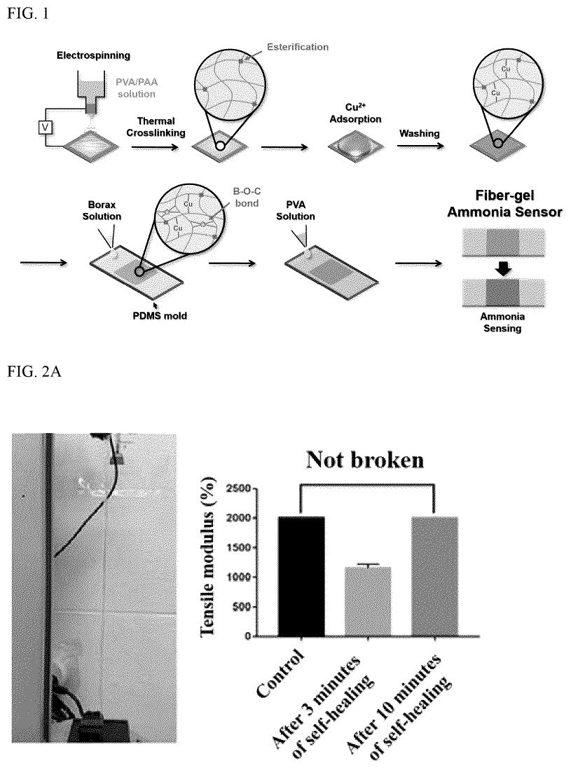

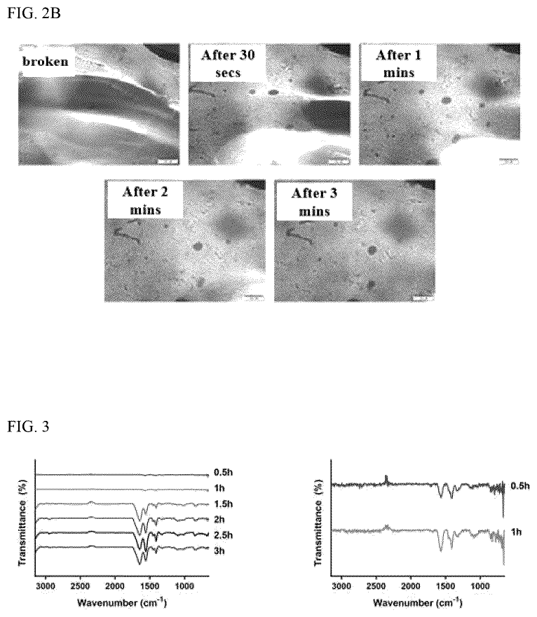

A set of optical microscope photographs confirming the self-healing property of the self-healable hydrogel of the present invention is illustrated in FIG. 2B.

As used herein, the term “transition metal” refers to an element having a d-orbital in the Periodic Table. All the elements of Groups 3 to 12 of the Periodic Table are included. The name transition metal was given because when the elements were listed in the order of atomic number in the early days of the classification of elements, they would play an intermediate role in transitioning to typical elements. Transition metals form complex compounds.

In an exemplary embodiment, the borax on a polyacrylic acid-polyvinyl alcohol-borax (PAA-PVA-Borax) fiber gel in which transition metal ions are dispersed may be bonded to polyvinyl alcohol (PVA) to be additionally input for hydrogelation.

In an exemplary embodiment, the transition metal ions may be selected from the group consisting of Sc, Ti, V, Cr, Mn, Fe, Co, Ni, Cu, Zn, Y, Zr, Nb, Mo, Tc, Ru, Rh, Pd, Os, Ir, Pt, Au and Hg.

In the examples of the present invention, cobalt ions (Co²⁺) and copper ions (Cu²⁺) were used to confirm the changes in colors of transition metal ions according to the type and concentration of ligands, but the types of transition metal ions are not limited thereto.

In an exemplary embodiment, the self-healable hydrogel may have a moisture content of 70 to 95 wt %, preferably 75 to 90 wt %, and more preferably 80 to 85 wt %.

When the moisture content is less than 70 wt %, it may be difficult to seal the gaps, and when the moisture content exceeds 95 wt %, it may difficult to maintain the shape because the concentration of the self-healable hydrogel is too low.

In an exemplary embodiment, the self-healable hydrogel may have a tensile modulus of 500 to 2000%, preferably 1000 to 2000%, and more preferably 1500 to 2000%.

As used herein, the term “tensile modulus” refers to the ratio of the original length of a material specimen to the elongated length of the specimen in the direction of a load in a tensile test or the like. The tensile modulus may be obtained by (length after tension/length before tension)*100 (%) at the moment of breaking.

In an exemplary embodiment, the thermal cross-linkage of the PAA and PVA may have a cross-linking rate of 10% to 50%, preferably 15% to 30%, and more preferably 15% to 25%.

As used herein, the term “thermal cross-linking rate” is quantified based on the transmittance at this time, assuming that the thermal cross-linking rate is 100% when sufficiently thermally cross-linked. In the examples of the present invention, the degree of thermal cross-linking of a fiber gel manufactured by thermal cross-linking for 3 hours or more was assumed to be 100%, and the degree of thermal cross-linking of the remaining fiber gel was expressed as a percentage. In this case, the thermal cross-linking rate of the fiber gel cross-linked for x hours was derived using the following Equation 1 based on the transmittance at a wavelength of 1713 cm⁻¹.

(thermal cross-linking rate)={1−(transmittance of fiber gel thermally cross-linked for ×hours)/(transmittance of fiber gel thermally cross-linked for 3 hours)}×100(%) Equation 1

Further, present invention provides a chemical detection sensor including a self-healable hydrogel.

In an exemplary embodiment, the chemical may be in a liquid phase or a solid phase.

In an exemplary embodiment, the chemical may be any chemical that reacts with a transition metal to cause a color change. Preferably, the chemical may be sodium hydroxide, acetic acid, ammonia, sodium bicarbonate, pyridine, sulfuric acid or hydrogen sulfide.

Further, the present invention provides a method for producing a self-healable hydrogel, the method including: a first step of preparing a polyacrylic acid-polyvinyl alcohol (PAA-PVA) nanofiber precursor solution;
a second step of producing polyacrylic acid-polyvinyl alcohol (PAA-PVA) nanofibers by electrospinning the nanofiber precursor solution of the first step, and then thermally cross-linking the electrospun nanofiber precursor solution;
a third step of adsorbing transition metal ions by mixing the polyacrylic acid-polyvinyl alcohol (PAA-PVA) nanofibers of the second step with a transition metal ion solution; and
a fourth step of manufacturing a polyacrylic acid-polyvinyl alcohol-borax (PAA-PVA-Borax) fiber gel by mixing the polyacrylic acid-polyvinyl alcohol (PAA-PVA) nanofibers onto which the transition metal ions are adsorbed of the third step with a borax solution; and
a fifth step of forming a polyvinyl alcohol-borax (PVA-Borax) hydrogel matrix by allowing the polyacrylic acid-polyvinyl alcohol-borax (PAA-PVA-Borax) fiber gel onto which the transition metal ions of the fourth step are adsorbed to react with a polyvinyl alcohol (PVA) solution.

The method for producing a self-healable hydrogel will be described in detail.

In an exemplary embodiment, a nanofiber precursor solution was produced by mixing a 10 wt % aqueous solution of polyacrylic acid (PAA, MW about 450,000) and a 10 wt % aqueous solution of polyvinyl alcohol (PVA, MW 89,000 to 98,000) at a volume ratio of 1:1, but is not limited thereto.

In an exemplary embodiment, the polyacrylic acid-polyvinyl alcohol (PAA-PVA) nanofiber precursor solution may include polyacrylic acid (PAA) at a concentration of 3 to 7 wt %, preferably 4 to 6 wt %, and more preferably 4.5 to 5.5 wt %, and polyvinyl alcohol (PVA) at a concentration of 3 to 7 wt %, preferably 4 to 6 wt %, and more preferably 4.5 to 5.5 wt %.

In an exemplary embodiment, nanofibers may be manufactured through a thermal cross-linking reaction after electrospinning the nanofiber precursor solution.

In an exemplary embodiment, the thermal cross-linking may be performed for hours to 2 hours, preferably 0.5 to 1.5 hours, and more preferably 0.7 to 1.3 hours, and may also be performed until a thermal cross-linking rate of 10% to 50% is achieved. When the thermal cross-linking rate is less than 10%, a sufficient amount of transition metal ions cannot be adsorbed due to the leakage of uncross-linked PAA, and it may be difficult to function as a sensor, and when the thermal cross-linking rate exceeds 50%, the bonding of PVA and borax on the nanofibers may not be smooth, so that the integration of the fiber gel and the hydrogel matrix may not occur, and the absorption capacity for chemicals may deteriorate.

In an exemplary embodiment, the transition metal ions may be adsorbed onto the nanofibers by spraying the transition metal ion solution, immersing the nanofibers in the transition metal ion solution, or any other methods that enable the nanofibers and the transition metal ion solution to be brought into contact with each other.

In an exemplary embodiment, the transition metal ion solution may be selected from the group consisting of Sc, Ti, V, Cr, Mn, Fe, Co, Ni, Cu, Zn, Y, Zr, Nb, Mo, Tc, Ru, Rh, Pd, Os, Ir, Pt, Au and Hg.

In an exemplary embodiment, the transition metal ion solution may include 0.05 to 1 M, preferably 0.1 to 1 M, and more preferably 0.5 to 1 M transition metal.

When the transition metal concentration in the transition metal ion solution is M or higher, it was confirmed that all the nanofibers are saturated with the transition metal regardless of the concentration, and at a concentration of 1 M or higher, it may be difficult to disperse or dissolve the transition metal in the transition metal ion solution at room temperature.

In an exemplary embodiment, the borax solution may be a 0.5 to 1.0 wt %, preferably a 0.6 to 0.9 wt %, and most preferably a 0.7 to 0.9 wt % aqueous borax solution, borax may react with the nanofibers by spraying the nanofibers with an aqueous borax solution, immersing the nanofibers in an aqueous borax solution, or any other methods that enable the nanofibers and the aqueous borax solution to be brought into contact with each other, and as a result of the above reaction, a polyacrylic acid-polyvinyl alcohol-borax (PAA-PVA-Borax) fiber gel may be manufactured.

In an exemplary embodiment, the polyvinyl alcohol (PVA) solution may be a 7 to 11 wt %, preferably an 8 to 10 wt %, and most preferably an 8.5 to 9.5 wt % aqueous polyvinyl alcohol solution, polyvinyl alcohol may be reacted with nanofibers by spraying the nanofibers with an aqueous polyvinyl alcohol solution, immersing the nanofibers in an aqueous polyvinyl alcohol solution, or any other methods that enable the nanofibers and the aqueous polyvinyl alcohol solution to be brought into contact with each other, and as a result of the above reaction, borax and polyvinyl alcohol on the polyacrylic acid-polyvinyl alcohol-borax (PAA-PVA-Borax) fibers react with each other to form a polyvinyl alcohol-borax (PVA-Borax) hydrogel matrix.

The present invention relates to a self-healable chemical sensor manufactured by mixing polyacrylic acid (PAA) and polyvinyl alcohol (PVA)-based nanofibers with polyvinyl alcohol (PVA) and borax.

Hereinafter, the present invention will be described in more detail through Examples.

### Example 1: Preparation of PAA-PVA Nanofiber Precursor Solution

A 10 wt % aqueous PVA solution was prepared by dissolving polyvinyl alcohol (PVA, Sigma-Aldrich) with a molecular weight of 89,000 to 98,000 in distilled water at 90° C. Then, a 10 wt % aqueous PAA solution was prepared by dissolving a polyacrylic acid (PAA, Sigma-Aldrich) with a molecular weight of about 450,000 in distilled water. Thereafter, a nanofiber precursor solution was prepared by mixing the two prepared solutions at a ratio of 1:1.

### Example 2: Manufacture of PAA-PVA Nanofibers by Electrospinning and Thermal Cross-Linking

After the precursor solution prepared in Example 1 was electrospun for 3 hours on a cover glass covered with an aluminum foil, the cover glass was dried at in a vacuum oven for 12 hours. Thereafter, thermal cross-linking was performed at 145° C. for 1 hour.

### Example 3: Manufacture of PAA-PVA-Borax Fiber Gel-Based Sensor with Adsorbed Transition Metal Ions

1 mL of a 1 M aqueous solution of transition metal ions was sprayed on the surface of the PAA-PVA nanofibers of Example 2 and the transition metal ions were adsorbed for 30 minutes. The nanofibers were gently washed with distilled water, and then placed in a PDMS mold. Then, 1 mL of a 0.8 wt % borax (Borax, Sigma-Aldrich) aqueous solution was injected into the PDMS mold to form a PAA-PVA-Borax fiber gel, and 1 mL of a 9 wt % aqueous PVA solution was injected into the PDMS mold to manufacture a PVA-Borax hydrogel matrix.

### Example 4: Fiber Gel Surface Analysis According to Thermal Cross-Linking Time

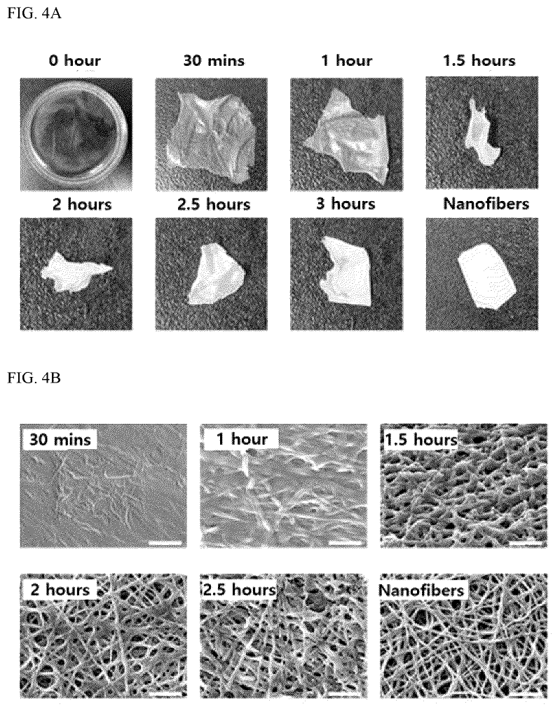

The PAA-PVA nanofibers dried in the vacuum oven of Example 2 for 12 hours were thermally cross-linked for 30 minutes to 3 hours to produce nanofiber samples with different degrees of cross-linking. Thereafter, a fiber gel was manufactured by reaction with a 0.8 wt % borax (Borax, Sigma-Aldrich) aqueous solution and dried, and then the surface was analyzed. (FIGS. 3, 4, and 5)

As a result of the experiment, the longer the thermal cross-linking time, the lower the degree of formation of the PVA-Borax hydrogel matrix of the fiber gel, showing physical properties similar to those of nanofibers. Theoretically, PVA-Borax gelation occurs through cis-diol bonding between hydroxyl groups of PVA chains mediated by borate derived from borax. This bonding is dynamic bonding, which imparts the material self-healing power and adhesive strength along with hydrogen bonding by the hydroxyl groups of boric acid and PVA. Therefore, since the degree of hydrogel matrix formation in the fiber gel may be determined by analyzing the residual hydroxyl groups in PVA that do not participate in thermal cross-linking, the degree of thermal cross-linking between PVA and PAA was confirmed through FT-IR analysis (FIG. 3). In order to quantify this, after assuming that the degree of thermal cross-linking of a fiber gel which was produced by thermally cross-linking for 3 hours based on the FT-IR data shown in 3 was 100%, the degree of thermal cross-linking of the remaining fiber gel was expressed as a percentage. In this case, the thermal cross-linking rate of the fiber gel cross-linked for x hours was derived using the following Equation 1 based on the transmittance at a wavelength of 1713 cm⁻¹.

(thermal cross-linking rate)={1−(transmittance of fiber gel thermally cross-linked for ×hours)/(transmittance of fiber gel thermally cross-linked for 3 hours)}×100(%) Equation 1

In this case, the thermal cross-linking rates of fiber gels produced by thermal cross-linking for 0.5 hours, 1 hour, 1.5 hours, 2 hours, and 2.5 hours were 6%, 20%, 90%, 96%, and 98%, respectively.

### Example 5: Experiment for Confirming Tensile Property and Self-Healing Power of PVA-Borax Hydrogel

After the self-healable hydrogel was cut, the surface was checked using an optical microscope to confirm the degree of self-healing over time. As a result of the experiment, it could be confirmed that most of the grooves caused by the cut surface were filled when self-healing for 5 minutes or more.

In addition, the tensile moduli before and after self-healing were compared. As a result of the experiment, it was confirmed that the tensile modulus before damage was restored when self-healing for 10 minutes or longer. (FIG. 2)

### Example 6: Adhesion Confirmation Experiment According to Material

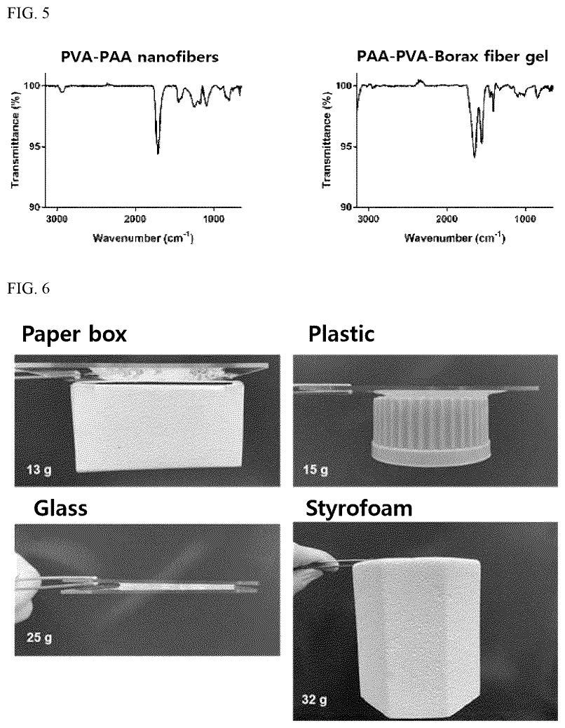

Each of objects with different weights and materials was attached to a slide glass using the self-healable hydrogel, and then dried for 30 minutes. Thereafter, it was confirmed whether the slide glass and the object were separated. As a result of the experiment, all of the slide glass (13 g), plastic (15 g), styrofoam (25 g), and paper box (32 g) maintained the attached state. (FIG. 6)

### Example 7: Detection of Liquid Chemical

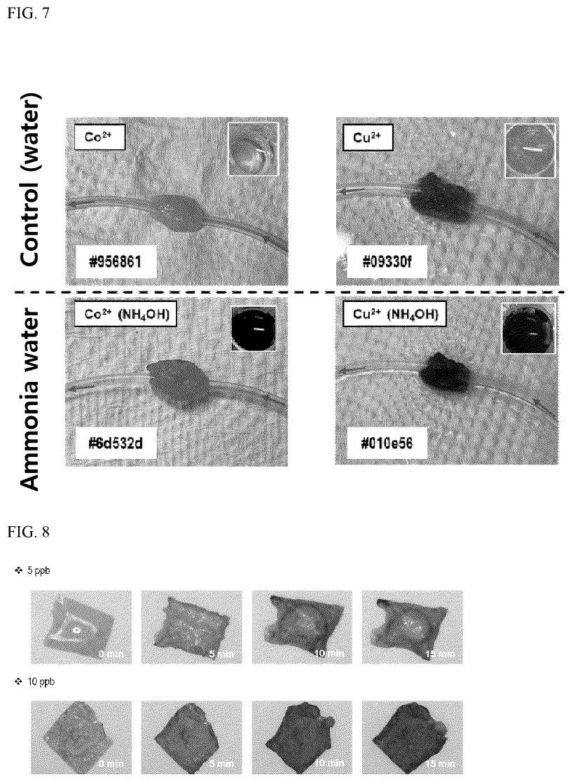

A fiber gel sensor with adsorbed Co²⁺ or Cu²⁺ was manufactured by the method described in Example 3, and then attached to the damaged portion of an artificially damaged PTFE tube. Thereafter, 1 M NaOH or 1 M NH₄OH was injected into the tube, and the change in color of the fiber gel sensor was analyzed using the hex code. Distilled water was injected into the control. (FIG. 7) Color changes occurred in both the Co²⁺-adsorbed sensor and the Cu²⁺-adsorbed sensor, and could be confirmed by the naked eye.

### Example 8: Quantitative Detection of Gas Phase Volatile Chemicals

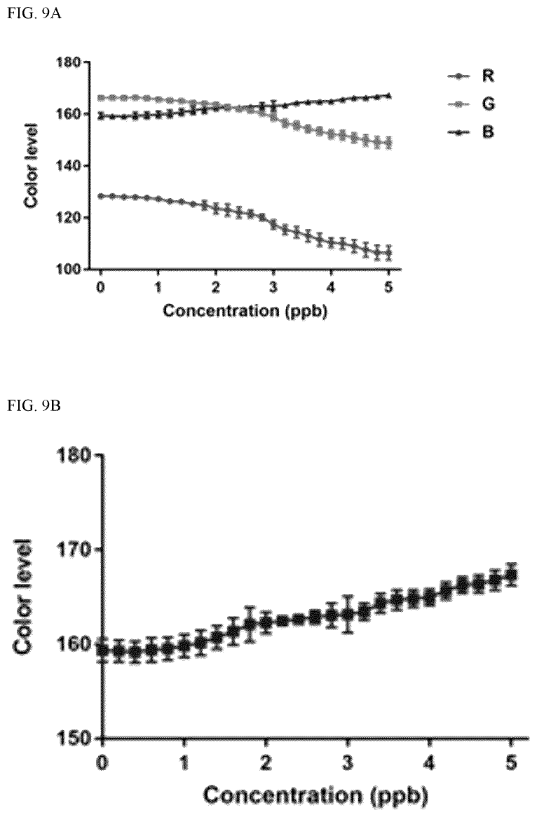

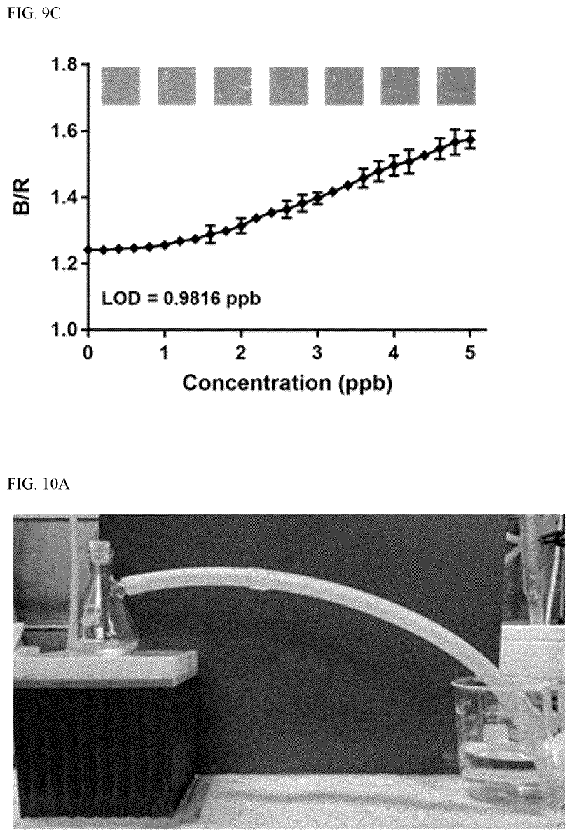

The fiber gel produced by the method in Example 3 was inserted into a reaction vessel, and NH₄OH was evaporated to create various concentrations. The color change of the fiber gel was captured in real time for 15 minutes, and the change in RGB values was analyzed. (FIG. 8) As a result of the experiment, it could be confirmed that the color of the fiber gel gradually darkened as time passed after the gas phase ammonia combined with Cu²⁺ ions. Furthermore, as a result of calculating the limit of detection (LOD) by converting the measured RGB values into Blue/Red values, it was confirmed that up to 0.9816 ppb could be detected. (FIG. 9)

### Example 9: Chemical Leakage Modeling Experiment

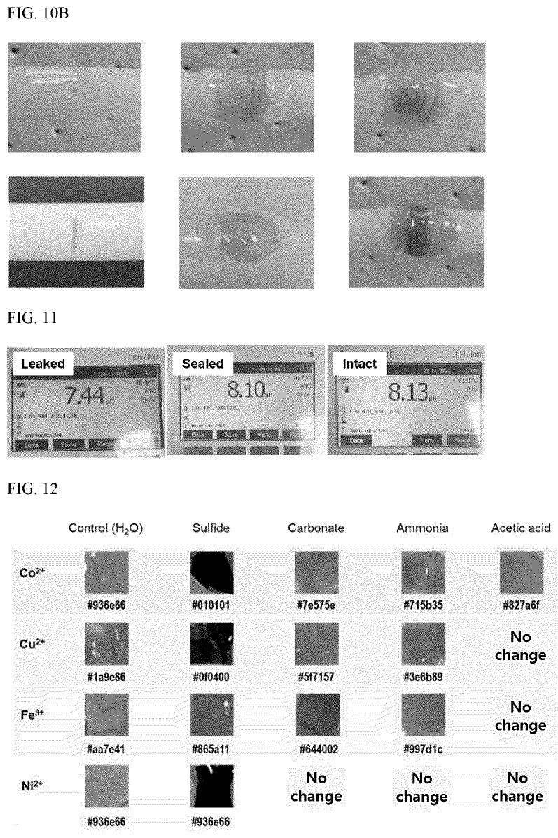

After a groove of 1 cm was made in a rubber hose, ammonia water was evaporated for about 5 minutes, and the ammonia gas was designed to move to a beaker containing distilled water through the rubber hose. In this case, after the groove of the rubber hose was sealed with the self-healable hydrogel composite prepared by the method described in Example 3, it was confirmed whether or not ammonia was detected. Ammonia was detected by adsorbing Cu²⁺ onto the PAA-PVA fiber gel. It was confirmed that the fiber gel sensor turned blue when ammonia water was allowed to flow. (FIG. 10)

### Example 10: Functional Experiment as Sealant

After a groove was in a rubber hose in the same manner as in Example 9 was sealed with a self-healable hydrogel composite produced by the method described in Example 3, ammonia water was evaporated to allow the ammonia gas to diffuse into a beaker containing distilled water. In this case, the sealing effect was analyzed by the pH change of distilled water appearing before and after sealing and when using an undamaged rubber hose. As a result, in the experimental group sealed with the self-healable hydrogel composite, a pH change similar to that of the undamaged rubber hose appeared, and in the unsealed experimental group, ammonia gas leaked out through the damaged area, so that the pH of distilled water did not increase significantly compared to the other experimental groups. (FIG. 11)

### Example 11: Diversification of Adsorbable Transition Metal Ions and Detection Chemicals

After a fiber gel sensor with adsorbed Cu²⁺, Co²⁺, Fe³⁺ or Ni²⁺ was manufactured by the method described in Example 3, the fiber gel sensor was cut into a size of 1 cm×1 cm, and a total of 5 pieces were placed in each well of a 24-well plate. Thereafter, 0.2 mL of DI water, 0.1 M sodium sulfide, 0.1 M potassium carbonate, 0.1 M ammonia water, and 0.1 M aqueous acetic acid solution were sprayed on each piece, and the change in color was observed and indicated with the hex code. As a result of the experiment, a macroscopically discernable color change for acetic acid appeared only in the Co²⁺-adsorbed fiber gel, which changed color for all the materials, and in the case of Ni²⁺-adsorbed fiber gel, the color changed only in sodium sulfide. In addition, in the case of Cu²⁺ and Fe³⁺, the colors changed for all the solutions except for acetic acid (FIG. 12).

Therefore, the self-healable hydrogel of the present invention may be custom-made using transition metals capable of ligand binding to gas and liquid components that can be expected to leak.

Since the present invention utilizes a functional hydrogel composite manufactured through thermal cross-linking and simple mixing, a plurality of sensors can be manufactured by a simple method.

The self-healable hydrogel composite of the present invention is not limited to one detectable material because the transition metal ions exhibit various colors according to the type of chemical acting as a ligand.

Transition metal ions bind to both liquid and gas phase ligands to exhibit color changes, and thus detection is possible regardless of the phase of a material to be detected.

Since the self-healable hydrogel composite of the present invention includes a fiber gel with the high surface area of nanofibers and the absorption capacity of a hydrogel, the self-healable hydrogel composite can contain large amounts of transition metal ions to effectively detect small amounts of chemicals.

The self-healable hydrogel composite of the present invention can be deformed into various shapes, and thus can effectively seal gaps and detect leakage without being greatly restricted by the shape of the leakage space of chemicals.

What is claimed is:

1. A self-healable hydrogel comprising a polyacrylic acid-polyvinyl alcohol-borax (PAA-PVA-Borax) fiber gel with dispersed transition metal ions,
wherein the PAA and PVA are thermally crosslinked, and
the PVA and Borax are covalently bonded.

2. The self-healable hydrogel of claim 1, wherein the transition metal ions are selected from the group consisting of Sc, Ti, V, Cr, Mn, Fe, Co, Ni, Cu, Zn, Y, Zr, Nb, Mo, Tc, Ru, Rh, Pd, Os, Ir, Pt, Au and Hg.

3. The self-healable hydrogel of claim 1, wherein the self-healable hydrogel has a moisture content of 70 to 95 wt %.

4. The self-healable hydrogel of claim 1, wherein the self-healable hydrogel has a tensile modulus of 500% or more.

5. The self-healable hydrogel of claim 1, wherein the self-healable hydrogel has a self-healing power of 80% or more.

6. The self-healable hydrogel of claim 1, wherein the thermal cross-linkage of the PAA and PVA has a thermal cross-linking rate of 10% to 50%.

7. A chemical detection sensor comprising the self-healable hydrogel of claim 1.

8. The chemical detection sensor of claim 7, wherein the chemical is in a liquid phase or a gas phase.

9. The chemical detection sensor of claim 7, wherein the chemical is sodium hydroxide, acetic acid, ammonia, sodium bicarbonate, pyridine, sulfuric acid or hydrogen sulfide.

10. A method for detecting a chemical, the method comprising: exposing the chemical detection sensor of claim 7 to a gas phase or liquid phase chemical;
confirming a color change of the chemical detection sensor; and
determining the type of chemical based on the type of transition metal in the chemical detection sensor and the changed color of the sensor.

11. A method for producing a self-healable hydrogel, the method comprising: a first step of preparing a polyacrylic acid-polyvinyl alcohol (PAA-PVA) nanofiber precursor solution;
a second step of producing polyacrylic acid-polyvinyl alcohol (PAA-PVA) nanofibers by electrospinning the nanofiber precursor solution of the first step, and then thermally cross-linking the electrospun nanofiber precursor solution;
a third step of adsorbing transition metal ions by mixing the polyacrylic acid-polyvinyl alcohol (PAA-PVA) nanofibers of the second step with a transition metal ion solution; and
a fourth step of manufacturing a polyacrylic acid-polyvinyl alcohol-borax (PAA-PVA-Borax) fiber gel by mixing the polyacrylic acid-polyvinyl alcohol (PAA-PVA) nanofibers onto which the transition metal ions are adsorbed of the third step with a borax solution; and
a fifth step of forming a polyvinyl alcohol-borax (PVA-Borax) hydrogel matrix by allowing the polyacrylic acid-polyvinyl alcohol-borax (PAA-PVA-Borax) fiber gel onto which the transition metal ions of the fourth step are adsorbed to react with a polyvinyl alcohol (PVA) solution.

12. The method of claim 11, wherein the polyacrylic acid-polyvinyl alcohol (PAA-PVA) nanofiber precursor solution comprises polyacrylic acid (PAA) at a concentration of 3 to 7 wt % and polyvinyl alcohol (PVA) at a concentration of 3 to 7 wt %.

13. The method of claim 11, wherein the thermal cross-linking is performed for 0.5 hours to 2 hours.

14. The method of claim 11, wherein the transition metal ion solution comprises transition metal ions selected from the group consisting of Sc, Ti V, Cr, Mn, Fe, Co, Ni, Cu, Zn, Y, Zr, Nb, Mo, Tc, Ru, Rh, Pd, Os, Ir, Pt, Au and Hg.

15. The method of claim 11, wherein the transition metal ion solution comprises 0.05 to 1 M of a transition metal.

16. The method of claim 11, wherein the borax solution is a 0.5 to 1.0 wt % aqueous borax solution.

17. The method of claim 11, wherein the polyvinyl alcohol solution is a 7 to 11 wt % aqueous polyvinyl alcohol solution.
